(19) United States
(12) Patent Application Publication
(10) Pub. No.: US 2012/0266676 A1
(43) Pub. Date: Oct. 25, 2012

(54) Method and device for improved measurement of ultrasound propagation time difference

(76) Inventors: Roland Mueller, Steinheim (DE); Gerhard Hueftle, Aspach (DE); Michael Horstbrink, Stuttgart-Feuerbach (DE); Tobias Lang, Stuttgart (DE); Samí Radwan, Stuttgart (DE); Bernd Kuenzl, Schwieberdingen (DE); Roland Wanja, Markgroeningen (DE)

(21) Appl. No.: 13/501,191

(22) PCT Filed: Aug. 18, 2010
(86) PCT No.: PCT/EP2010/062062

§ 371 Date: Jun. 29, 2012

(30) Foreign Application Priority Data
Oct. 12, 2009 (DE) 102009049067.1

(51) Int. Cl. G01N 29/00

(52) U.S. Cl. 73/632

(57) ABSTRACT

A method for measuring a propagation time difference includes: sending a transmitted ultrasound pulse, which is provided with a transmission reference instant and which includes an envelope and a carrier frequency, into a spatial region and receiving a received ultrasound pulse that corresponds to the transmitted ultrasound pulse transmitted. A coarse time difference is provided by comparing the transmission reference instant with an envelope of the received ultrasound pulse, for at least two cycles of transmission/reception in opposite directions of transmission. A fine time difference is provided by comparing the transmission reference instant with an instantaneous variation of the received ultrasound pulse, for the at least two cycles of transmission/reception in opposite directions of transmission.

### BACKGROUND OF THE INVENTION

1. Field of the Invention

The present invention relates to a method and device for improved measurement of ultrasound propagation time difference.

2. Description of Related Art

It is known from the field of acoustics to emit ultrasound into a space and to infer properties of the space on the basis of the sound waves transmitted in the space. In this context, the change in the signal due to transmission within the space forms the physical basis for the detection of characteristics of the space.

That physical basis is used to detect, in particular, a propagation time or a propagation time difference in order to detect therefrom properties of a flow within the space. Examples of applications are to be found, for example, in automotive engineering where flow sensors are used for detecting the inflowing quantity of air and for proportioning the fuel or fuel mixture. In principle, ultrasonic flow sensors (including those constructed in accordance with the present invention described hereinafter) may be used in all fields of technology in which a flow rate or flow speed or other flow properties within a space are to be detected.

The accuracy that is achievable with such ultrasonic detectors is limited by the accuracy of the ultrasonic transducer and by the strength of the noise signal caused by interference outside the sensor. Such interference is, for example, interference radiating from the surrounding area, in particular interference caused by flow noises, valves, pumps or the like. For reasons of both cost and space, transducers cannot be provided with unlimited accuracy and emission power, and therefore, in ultrasonic flow sensors of the related art, problems arise with regard to precision, it not being possible to compensate completely for the precision problems by using high-precision, and hence costly, sensors.

It is known from published German patent application document DE 10 2005 037458 A1 to provide an ultrasonic flow sensor with drift compensation, where an offset error of the ultrasonic transducer is detected and is taken into account in the measurement of the propagation time. The device described therein includes evaluation electronics that are based on the detection of the phase shift between the signals. The combination according to the invention is used to take account of the aging of a transducer, which has an effect on the driving behavior.

Published German patent application document 10 2007 027188 A1 also discloses an ultrasonic sensor that is based on the detection of the phase shift between received signal and transmitted signal. That document proposes using different demodulation frequencies and making an unambiguous phase measurement range of a plurality of ultrasound periods possible with the aid of a so-called Nonius unit.

Published German patent application document 10 2004 014 674 A1 describes an ultrasonic flow sensor wherein a zero crossing of the ultrasound signal is determined as the instant of reception after a predefined threshold value of the low-pass-filtered signal amplitude of the ultrasound signal has been exceeded.

The mechanisms described in the related art for combination of errors are limited in terms of the precision attained and also permit only a limited unambiguous detection of the propagation time, since only the phase is considered.

### BRIEF SUMMARY OF THE INVENTION

It is therefore an object of the present invention to provide a method and a device for improved measurement of ultrasound propagation time or propagation time difference.

The present invention permits a distinct improvement of the precision in ultrasound propagation time measurements without necessitating the use of costly high-precision ultrasonic transducers and correspondingly accurate calculation circuitry. In particular, the present invention makes possible an unambiguous detection of the propagation time difference over a large measuring range, that is, over a plurality of ultrasound periods. In principle, the present invention makes it possible to detect the propagation time difference over a substantially unlimited measuring range without, however, making it necessary to accept reduced precision. As a particular advantage, the present invention makes possible not only a favorably priced, simple realization, but also a distinctly simplified reduction of the amount of computation work as compared with the related art, without reducing precision or measuring range with regard to measurement of the propagation time difference of the sensor. Special embodiments of the present invention further provide a low time resolution of the data that are to be processed, or a distinct reduction in the time resolution of the sensed or sampled transducer signals, as a result of which the work involved in processing is reduced and it is possible to use inexpensive components without it being necessary, however, to accept a substantial deterioration in terms of accuracy.

Above all, the present invention makes it possible to compensate for aging processes and for distortions caused by the transducer (especially delays due to the response behavior of the transducer) by carrying out a differential evaluation or rather the combined evaluation according to the present invention of sound pulses transmitted in opposite directions. In this case, an evaluation of the propagation time in two mutually opposite wave propagation directions compensates for the transducer behavior and, in particular, the combination of fine time differences and the combination of coarse time differences of sound pulses running in opposite directions, with the two combinations being suitably combined once again for detection of the propagation time difference.

The concept underlying the present invention is to combine a detection of the propagation time on the basis of an envelope with a detection of the propagation time on the basis of the phase relationship between instant of transmission and received pulse, i.e., by a measurement of the phase of the instantaneous amplitude variation of the same transmitted/received pulse, this being carried out for sound pulses in two mutually opposite directions of transmission.

The determinations of the propagation time of the same sound pulse, but on the basis of different characteristics of the associated transducer signal (i.e., on the basis of the envelope and on the basis of the instantaneous phase variation) are referred to as different detection modes. The two time difference determinations of different detection modes, which are performed on the basis of considering the phase of the instantaneous amplitude variation and on the basis of detecting the envelope at the same received pulse, are thus carried out for an ultrasound pulse in one direction of transmission and for an ultrasound pulse in the opposite direction. The results of the time difference determinations are combined, producing error compensation effects for errors caused by the transducer behavior. The combination according to the present invention of the determined time differences provides that the time differences detected on the basis of the same detection mode, but for reversed directions of transmission are combined with each other to form individual combinations of the same detection mode, and the resulting individual combinations of the two detection modes are combined with each other in order to provide the propagation time difference as the end result of the propagation time difference detection method. In detail, the fine time differences (determined by consideration of the instantaneous amplitude variation) of sound pulses of differing direction of transmission are combined, and the coarse time differences (determined by consideration of the envelope) of sound pulses of differing direction of transmission are combined to form individual combinations, especially by subtraction or alternatively addition.

For determination of the end result (i.e., the propagation time difference) those individual combinations are combined with the aid of a higher-order combination, for example by subtraction. That higher-order combination provides that a term that includes the individual combination of the coarse time differences (i.e., the difference thereof, or the coarse propagation time difference) is rounded and that the rounded term is combined with the individual combination of the fine time differences (i.e., the difference thereof, or the fine propagation time difference), preferably by addition. The term that is to be rounded preferably also includes the fine propagation time difference which is subtracted from the coarse propagation time difference within the term. The fine propagation time difference, the coarse propagation time difference or both differences within the term may be multiplied by an adaptation factor so that, after multiplication, both propagation time differences are represented in the same domain, for example as angle information or time information.

The term that is to be rounded further includes a rounding compensation constant which is updated. The rounding compensation constant is updated in accordance with the distance of the term to be rounded, or of the rounding argument, from the rounded term, or from the adjacent rounding limits, in order that the term to be rounded is kept by the rounding compensation constant on an average or, by way of a moving average, in the middle between the two rounding limits of the rounding. In that manner, a jump to the next discrete rounding value, caused by usual dispersions, is avoided. In particular, the updating of the constant, which is added to the rounding argument in the form of a value that is to be added, makes it possible to compensate at least partially for phase drifts or time drifts which give rise to slowly changing transducer properties or asymmetries in respect of the sound transmission, for example because of a flow. Such drifts are absorbed by the constant, which naturally exhibits the same time behavior as the drifts. The constant may be updated by determining the two intervals between the rounding argument with the inclusion of the constant and the two closest rounding limits for at least one measurement. The intervals are accumulated, for example with a moving average or with the aid of a low-pass filter. For a following detection of the propagation time difference, the constant is provided in such a way (for example by reducing or increasing the constant) that the constant for the past measurements provides the argument substantially in the middle between the rounding limits, and that constant is used for the following detection of the propagation time difference. When fine time differences and coarse time differences of opposite directions are combined by subtraction, the two associated constants cancel each other out at least to some extent, and therefore a constant that is to be updated within the rounding argument would not be absolutely necessary. Complete cancellation occurs in principle only for strictly symmetrical or reciprocal transmission situations. That ideal state exists only in the case of an isotropic transmission medium, which must not, therefore, have a macroscopic flow state, for example. By contrast, in the case of a flow, apart from the propagation time difference (to be measured), the rounding argument also may possibly move away from the middle between the two respectively adjacent rounding limits. This may be caused, for example, by the development of beam drifting of differing extent in the direction of flow and counter to the direction of flow, with the result that different regions of the spatial emission or receiving characteristic of the ultrasound transducers, and hence slightly different transmission functions, are active in both directions of transmission. For that reason, a constant that is to be updated is preferably used, which is based in its updating on the middle between the two rounding limits (as the target).

In accordance with the present invention, therefore, it is provided that the coarse and fine differences for mutually opposite directions are detected and that first, for each detection mode separately, the time differences associated with different directions of transmission are combined. The combinations carried out individually for each detection mode are in turn combined in a higher-order combination. The higher-order combination provides that the combination of the coarse time differences (provided as a subtraction) and the combination of the fine time differences (provided as a subtraction) are combined, preferably with the inclusion of the rounding compensation constant (which is to be added), and that the combination obtained is rounded. The result of the rounding is combined with the fine time difference by addition. Thus, the detection of the propagation time difference includes merely the combination of time differences as a subtraction of two time differences transmitted in different directions. In comparison with an absolute method of measurement, this differential method of measurement results in compensations for transducer properties that the transducers possess in equal measure as transmitters and as receivers. “Time differences” refers here to periods of time obtained between transmission and reception.

By the use of different detection modes, the ambiguity of the phase measurement is completely compensated for on the basis of the information obtained from the propagation time detection, and the inaccuracy of the propagation time measurement is completely compensated for by the accuracy of the phase measurement. In order to be able to reconcile the information from the phase measurement with the information from the propagation time measurement, the envelope of the transmitted/received ultrasound pulse is considered in order to be able to obtain first, coarse time information from the propagation time measurement. To increase precision, that information is supplemented by information obtained from the phase measurement. Considered in a different way, the accurate, but ambiguous information from the phase measurement is made useable for a greater propagation time range by combining that information with the coarse information from the consideration of the envelope. The information from the envelope makes it possible to place the phase information, which is ambiguous owing to the periodicity of the carrier signal, in the broad context of the envelope, in which case the (per se) ambiguous phase information may, where applicable, be unambiguously extended, with the aid of the (coarse) propagation time information, to a very large measuring range.

Whereas the phase and the instant or the envelope of the received ultrasound pulse are actually detected, for example by calculating or constructing a time reference point in the wave curve, the detection of the transmitted ultrasound pulse merely provides for a time reference point to be made available, i.e., a transmission reference instant, for example in the form of a trigger impulse of a time mark or on the basis of the electrical driving signals of the transducer. Since the shape of the driving signals is basically distorted and also delayed by the transducers (for example by oscillators coupled thereto and by resonance behavior of the transducers), the detection (of a time reference point) of the received ultrasound pulse requires an actual analysis (of the phase and the shape of the envelope), whereas the time reference point of the transmitted ultrasound pulse in the form of a driving signal is specified by a controller. The transmission reference instant relates to the transmitted ultrasound pulse in its representation as an electrical signal and may be obtained from a trigger signal or driving signal, where applicable with the inclusion of a delay that is constant or assumed to be constant. Similarly, for the acoustic transmitted ultrasound pulse there is a clear dependence on the driving signal, that dependence depending in turn on the transducer properties (response behavior) and including, where applicable, a predetermined delay.

Furthermore, changes in the transducer properties may give rise to errors caused by a slowly increasing phase error in the transducers. Since those phase errors, at least in a reciprocal transmission situation, are the same for a transducer in transmission mode as in receive mode, by calculating the difference (i.e., by the above-mentioned subtraction) of the fine time difference (and the coarse time difference) it is possible to compensate for both mutually opposite directions of transmission. In addition, an additive constant may be added to the term used as the argument for the rounding, in which case a rounding with the inclusion of the constant is obtained. The constant may be updated according to the interval between the rounding argument and the rounding thresholds (or one of the two rounding thresholds). The expression “interval” refers here to the interval between rounding thresholds and a time-averaged rounding argument (or a rounding argument that includes earlier detection, and especially includes the preceding detection). Thus, if a phase drift (i.e., a slowly increasing phase shift relative to the coarse time difference) occurs, by integrated or low-pass-filtered updating of the constant within the rounding term it is possible to avoid a situation where a phase drift accumulates with time, which leads to a rounding into the next period of the instantaneous amplitude variation, and thus an inappropriate phase jump occurs in the detection of the propagation time or propagation time difference (as the end result). The expression “a constant” therefore refers to a value that changes only slowly with the phase drift in order to compensate for that phase drift, in contrast to the time differences, propagation times and propagation time differences which (in comparison therewith) change rapidly.

The expressions “received ultrasound pulse” and “transmitted ultrasound pulse” refer equally to acoustic waves and their electrical equivalent on the other side of the transducer. During the conversion between the electrical side and the acoustic side (and vice versa), delays and/or distortions may occur. Time differences (i.e., fine and coarse time differences) refer to periods of time that characterize the time interval between received pulse and transmitted pulse (or instant of transmission).

To produce the unambiguity of the phase information and to extend its value range to a plurality of ultrasound periods or to more than 2n, the envelope of the ultrasound pulse is considered, the curve of which is used for corresponding coarse registration. For coarse detection of the propagation time, therefore, the envelope is used in order to bring the shape of the envelope of the transmitted ultrasound pulse (more specifically: the transmission reference instant) into agreement with the shape or a feature of the shape of the envelope of the received ultrasound pulse and in that manner detect a coarse time difference. A feature of the shape of the envelope refers, for example, to a first rising edge of the envelope or also to a first maximum. The coarse time difference corresponds to the propagation time information obtained from considering the propagation time alone. In addition, in accordance with the present invention, a fine time difference is detected, which corresponds to the information resulting from the phase detection. The phase detection is based on consideration of the phase of the carrier signal and therefore is naturally unambiguous only within a whole period (that is to say, 0° to 360° or 0 to 2π or −π to +π or a comparable range). The envelope of the transmitted ultrasound pulse (especially the transmission reference instant, for example a trigger signal or a time signal determining the instant when the ultrasound pulse is generated) and the envelope of the received ultrasound pulse may be brought into agreement by a conventional correlation function or, equally, by a matched filter applied to the envelope of the received ultrasound pulse, the coarse time difference being obtained from that correlation or from the result of the matched filter in comparison with the transmission reference instant. Apart from a correlation, other mechanisms may also be employed for detection of a time offset, especially of a feature of the received ultrasound pulse with which the transmission reference instant is compared, for example by detecting a feature such as a maximum, an inflection point, a minimum or a zero crossing of the envelope, the first or the second time derivative of the envelope of the received ultrasound pulse and comparing it with the transmitted signal (i.e., with the transmission reference instant) using a synchronization device, a timer (for example a counter) or the like in order to detect the time offset, that is to say, the coarse time difference between transmitted and received ultrasound pulse. The inflection point is detected by detecting a maximum of the gradient of the envelope or a zero crossing of the second time derivative of the envelope. The received ultrasound pulse does not necessarily have to be compared with the transmitted ultrasound pulse, but may also be compared with a signal that is output to the transducer or with which the transducer including pre-stage or also including pulse-shaping filter is driven. For example, the comparison with the transmitted ultrasound pulse may be provided by a comparison with a trigger signal, for example with an edge with which a signal generator (for example includes a pulse-shaping filter) is driven or triggered in order to detect the transmitted ultrasound pulse by driving of the ultrasonic transducer.

The consideration of a time difference (that is to say, in particular, the consideration of the coarse time difference and the fine time difference) is equivalent to a consideration of the respective phase, it being generally known that phase and time difference are directly proportional over the carrier frequency. Therefore, features mentioned herein that relate to a time difference are also to be understood directly as features that relate to a phase consideration, and vice versa.

The method according to the present invention for measurement of the propagation time difference therefore includes a step of sending a transmitted ultrasound pulse into a spatial region, the transmitted ultrasound pulse being provided with a carrier frequency and having an envelope. In order to resolve the ambiguity of the fine time difference (that is, the phase information), the envelope includes not only a DC signal component (DC), but also an AC signal component (AC), even if the AC signal component consists only of a rising or falling edge. In principle, it is possible to use as the envelope any desired signal that does not exhibit a constant signal strength at all times, but which has at least one edge. Particularly preferred, however, are envelopes with an autocorrelation function having a maximum that differs greatly from the value of the autocorrelation function at a different place. The duration of the envelope, i.e., the period of time for which the signal strength is not zero, includes a large number of carrier signal periods. Also preferred are envelopes of a duration which is very great in comparison with the period length of the instantaneous amplitude signal (for example greater than 100 1/f_{carrier} or a length of the envelope amounting to 5, 10, 20, 50, 100, 200 or 300 times the period length of the carrier signal).

In accordance with a general consideration, orthogonal signals are suitable for defining the curve of the envelope for carrying out the present invention. When periodic envelopes are used, the length of the periodicity of the envelopes is greater than the measuring range of the propagation time measuring method for which it is used. There are considered as the envelope, in particular, individual pulses that are not longer than an assumed total propagation time (that is, outward and return journey of the ultrasound signal) and that are repeated after a further echo settling time. In particular, the envelope ends when the beginning of the envelope already arrives at the receiver (that is, at the transducer), preferably including an additional guard period during which a sensor device switches from transmitting to receiving. The possible periodicity of the envelope considered above concerns only a repetition of the signal waveform within one and the same envelope; in particular, this does not refer to the repeated emission of envelopes for repeated sensing of the surroundings. The envelope is thus associated with one and the same sensing period and, in particular, does not encompass more than one individual sensing period or transmission portion thereof at the beginning of the sensing period. The length of the envelope is therefore defined by the assumed maximum outward and return journey within the sensor, the length of the outward and return journey being determined by structural factors of the sensor, for example the distance between transducer and opposing reflector or opposing wall or distance between the transducers.

The transmitted ultrasound pulse is received as the received ultrasound pulse, the latter corresponding to the transmitted ultrasound pulse reflected in or radiated through the spatial region. Within the spatial region, there is a flow whose properties are detected by the propagation time measurement. In particular, the propagation time difference later obtained is directly dependent on the flow speed within the spatial region, and therefore it is possible to infer the flow speed from the combined time differences (that is, from the measured propagation time or propagation time difference). The time differences between the transmitted ultrasound pulses and the received ultrasound pulses are detected as the (differential) propagation time; the propagation time difference in turn is a physical measured quantity from which the physical properties of the flow may be derived.

In accordance with the present invention, the transmitted ultrasound pulse is sent from (at least) one (further) transducer that differs from the transducer with which the received ultrasound signal is sent. In accordance with the preferred embodiment, the sending and the receiving are repeated (e.g. are carried out twice or alternately), in which case first a first transducer emits the transmitted ultrasound pulse which, after passing through the spatial region, is received as the received ultrasound pulse by a second transducer. As described above, the time differences between sending and receiving (as propagation time components) are measured according to the present invention. Then, the functions of the transducers are reversed for a further propagation time measurement according to the present invention. In the further propagation time measurement, the second transducer, i.e. the transducer that detected the received ultrasound pulse in the previous propagation time measurement, emits the transmitted ultrasound pulse, and the first transducer, i.e., the transducer that emitted the transmitted ultrasound pulse in the previous propagation time measurement, receives the received ultrasound pulse. Thus, the method according to the present invention is repeated, especially the steps of receiving and sending, the functions of sending and receiving being reversed when the propagation time measurement is repeated. In the same manner, the propagation paths are reversed: whereas the sound propagates from the first transducer to the second transducer in the first propagation time measurement, when the propagation time measurement is repeated the sound is transmitted from the second transducer (through the spatial region) to the first transducer. The repetition may be carried out once or several times, but with the transmitted ultrasound pulse preferably being emitted roughly equally often by all (i.e., by both) transducers and the direction of transmission of the ultrasound pulse accordingly changing n times, where n is a number greater than zero.

Furthermore, the sending and receiving may be provided in concatenated form, in which case a first pulse is transmitted from a first transducer to a second transducer, and the associated first fine time difference and first coarse time difference is detected. Then, a second pulse is transmitted from the second transducer to the first transducer, and the associated second fine and coarse time differences are detected. A third pulse is sent again from the first to the second transducer, and the associated third fine and coarse time differences are detected. Not only are the first and second pulse and the third and a further pulse combined in the sense of consecutive pairs, but the second and the third pulse are also used for a further measurement. Time differences of consecutive groups or pairs of pulses in general are evaluated, the combinations of the detected time differences being carried out within the groups or pairs. Various pairs or groups of pulses either may have no measurements for the same pulses (example: pulses Nos. 1, 2, 3, 4; combinations: ½ and ¾, but not ⅔ or 2/4) or the differential consideration includes the combination of pulses of different groups, that is to say, the multiple use of time differences of one and the same pulse (example: pulses Nos. 1, 2, 3, 4; in addition to the combinations ½ and ¾: combination ⅔). Accordingly, it is also possible to provide a running difference calculation (for example as combinations of one and the same time difference with a subsequent time difference and a preceding time difference, each belonging to an opposite direction of transmission).

That alternating (because it reverses the propagation direction) embodiment of the present invention provides differences in the fine and coarse propagation time in one direction minus the fine and coarse propagation time in the reverse direction. From the differences it is possible directly to infer the physical properties of the sound medium transmitting the at least two sound pulses propagating in opposite directions within the spatial region.

The propagation time difference is preferably given by:

Δt=(φ₁−φ₂)/2π+round((t0₁−t0₂)·f_{rec}−(φ₁−φ₂)/2π+x))

where:
Δt=propagation time difference
φ₁=fine time difference between transmitted and received pulse in the first direction of transmission
φ₂=fine time difference between transmitted and received pulse in a direction of transmission opposite the first direction
t0₁=coarse time difference between transmitted and received pulse in the first direction of transmission
t0₂=coarse time difference between transmitted and received pulse in a direction of transmission opposite the first direction
f_{rec}=frequency of the carrier signal of the received pulse.
(φ₁−φ₂)/2π is a term that describes the time difference for the transmissions carried out in two mutually opposite directions, and concerns the components of the detection that are provided as fine time differences on the basis of the phase comparison. A “fine time difference” here is merely the difference between the transmitted and received pulse of an individual transmission.
(t0₁−t0₂)·f_{rec} is a term that describes the difference in the coarse time differences and corresponds to a component of the time difference that is detected on the basis of the envelope (in both directions). That term is corrected by the component of the time difference that is based on the detections of the fine time differences before rounding takes place. That corrected term of the coarse time difference is rounded because the coarse time differences are subject to errors and serve merely to classify the detection result in a particular carrier wave period (or half-wave). In the case of a continuous change in the propagation time from measurement to measurement (based on the same direction of transmission in each case), the result of the rounding assumes a stepped pattern which jumps to the next step precisely at the point when the associated phase exceeds the phase measuring range (e.g. 0° to 360°). By addition with the phase-based detection result, the overall result is made more precise or the ambiguous phase-based detection result is extended by the addition to a larger phase measuring range.
x is a rounding compensation constant which is selected (and where applicable updated) in such a way that

(t0₁−t0₂)·f_{rec}−(φ₁−φ₂)/2π+x)−round((t0₁−t0₂)·f_{rec}−(φ₁−φ₂)/2π+x))

remains zero or close to zero on a time average. Here, x is a summand which is added to the argument of the rounding, the difference between the argument of the rounding and the rounded argument being detected in order to average that difference over time (for example using an integrator or by averaging over a time window). In that manner, a developing deviation due to increasing phase shift (i.e., a phase drift caused by the transducer) is detectable. In order to avoid rounding errors (in the form of jumps), x is slowly updated (for example low-pass-filtered) so as to compensate at least partially for the drift.

In accordance with that embodiment, the individual results, i.e., the fine time differences and the coarse time differences produced by the first and the repeated measurement, are combined with each other (for each detection mode individually). That combination may be provided by: adding the time differences, (arithmetic) averaging of the time differences or by finding the relative difference of the time differences (i.e., the duration of transmission given by the phase and envelope difference). In particular, that combination is provided by subtracting all the individual fine and coarse time differences obtained in one direction of propagation from the fine and coarse differences obtained in the reverse direction of propagation. The combination concerns measurements within a short period of time within which it may be assumed that flow conditions within the spatial region have not changed significantly. There are linked to the measurement results, in particular, physical quantities such as temperature, atmospheric humidity and speed of sound of the acoustic medium, which change distinctly more slowly than do the flow conditions and which therefore may be provided from the measurements by time-averaging. By virtue of the physical linking, it is also possible for the above-mentioned physical quantities to take the place of the above flow conditions. Alternatively, the combination concerns all time differences within a sliding time window, where the propagation time or propagation time difference provided represents an average value for that time window. Instead of combination over a time window, the individual time differences may also be integrated over time.

A propagation time difference measuring device according to the present invention includes a combination device configured to carry out those combinations. Preferably, the propagation time difference measuring device further includes a memory in which a plurality of time differences are stored (i.e., at least those of the first measurement and those of the repeated measurement with the direction reversed). The memory is connected to the combination device and outputs the individual time differences to the combination device.

In principle, the spatial region may be provided between the various transducers, or the transducers may be provided on one side of the spatial region, in which case a reflector is provided on the opposite side.

By combination of the fine and coarse time differences relating to transmissions of the transmitted ultrasound pulse in opposite directions, errors that are caused by transducers and that arise in absolute time measurements of the propagation time cancel each other out since, by virtue of the combination, only the relative amount of the delay by which the propagation time of a pulse transmitted in one direction differs from the propagation time of a pulse transmitted in the reverse direction is provided. For that reason, particular preference is given to combinations in which propagation times of different directions are subtracted from each other.

On the one hand, the desired error compensations occur when a propagation time difference is determined, since changes in the propagation time due to aging, for example, are approximately the same in both directions of transmission and therefore, even within the unambiguous range of a normal phase measurement, it is still possible to compensate for even small propagation time drifts by calculation of the difference. On the other hand, further compensations occur whereby, in addition, the unambiguous range of the phase measurement may be considerably extended without the need to use additional empirical constants, since phase drifts relative to the shape of the envelope curve or to the coarse time difference cancel each other out in the combination by calculation of the difference. Empirical constants (which describe a phase lag caused by a transducer) could, after an initial compensating effect, lose their validity over time, for example owing to aging. It would indeed be possible to compensate for this by updating, but any errors occurring despite updating would lead to erroneous measurements whose effects may be of any duration.

As an alternative to the above-mentioned alternating reversal of the function of the transducers as transmitters and receivers and vice versa, it is also possible to transmit at both transmitters simultaneously or at only slightly staggered times and to reverse the function of the transducers while the ultrasound pulses are still propagating in the spatial region that is to be measured. The transmitting/receiving phases may therefore overlap in time for two (or more) transducers or may coincide.

The coarse time difference is provided by comparing the envelope of the transmitted ultrasound pulse with an envelope provided by the received ultrasound pulse. The comparison concerns the time difference between the two ultrasound pulses and may, as described above, be determined by correlation, with the aid of a matched filter (configured in accordance with the envelope of the (acoustic) transmitted ultrasound pulse), by consideration of a trigger signal that indicates a beginning of the transmitted ultrasound pulse, or a transmission reference instant that indicates the time position of the transmitted ultrasound pulse, and an associated curve portion of the envelope of the received ultrasound pulse, for example a rising edge; by consideration of curve features of the envelope of the received ultrasound pulse or its first or second time derivative, for example a maximum, a minimum, a zero crossing or an inflection point, the instant at which a fixed or variable trigger threshold is exceeded, or also a rising or falling edge on the basis of the associated instant in the envelope of the transmitted ultrasound pulse; or by other comparison methods from which it is possible to detect the time offset between the transmitted ultrasound pulse and the received ultrasound pulse. The coarse time difference may thus be detected, for example, with the aid of a counter or any other suitable evaluation logic, preferably in a digital manner in a microprocessor. In the same manner, the comparison is provided by comparison of digital signals, preferably using a microprocessor, in which case the corresponding method features may be implemented by software, by hard-wired circuits or by a combination thereof.

In addition, the fine time difference is provided as the result of a step of comparing a phase of the carrier signal. In this case, the phase variation of the carrier signal of the transmitted ultrasound pulse (or of the transmission reference instant) is compared with the phase variation of the carrier signal of the received ultrasound pulse. That step of comparing corresponds to the comparison of instantaneous amplitudes between transmitted and received ultrasound pulse. The fine time difference is therefore based on the direct signal variation as received by the transducer, it also being possible, however, to use signals derived therefrom with respect to time.

In accordance with the present invention, the fine time differences are combined with the coarse time differences, for example by addition of combinations of fine time differences of different detection steps with combinations of coarse time differences of different detection steps, the detection steps relating to opposite directions of transmission. In particular, the combination may consist of providing the combination of the coarse time differences only as an integral multiple of a period length or a half-period length (for example by rounding the non-rounded combination of the coarse time differences minus the combination of the fine time difference as the rounding argument), and the “decimal place”, that is to say, the corresponding exact fraction within the period or half-period as (combination of the) fine time differences.

In some types of transducer, for example piezo transducers, the envelope is provided by the response behavior of the transducer to a square-wave driving signal or impulse and is defined by inertia, resonance behavior, transient response, post-pulse oscillation and interaction with further oscillating systems. The following consideration relates to transducers where it is approximately assumed that they reproduce the driving signal in substantially undistorted form, especially with regard to the envelope. Such transducers are assumed as ideal transducers and are used to explain the principles of the present invention, but not to explain realizations in practice, since real transducers each have their own fundamental driving characteristics. A further embodiment of the present invention therefore provides that the envelope or even only a portion of the envelope is provided in such a way that the associated autocorrelation function of the envelope has at least one maximum. In the case of several maximums, the greatest maximum preferably differs clearly from the other maximums and, in particular, the two greatest maximums differ by a minimum amount in order to avoid ambiguities in the coarse time difference. In accordance with a further embodiment, which may be combined with the latter embodiment, the entire curve of the envelope, but preferably only a portion of the envelope, is a strictly monotonic function of time. In other words, at least in portions, the envelope is not constant, the expression “monotonic function of time” referring to functions that do not have the same value for two instants, even if those instants follow one after the other in direct succession. As an alternative to strictly monotonic functions, a rectangle function may also be provided which, although having a less significant autocorrelation function, makes it possible to obtain precise information about the coarse time difference on the basis of the edges. In particular, a simple function like the rectangle function permits a simple implementation of the evaluation circuit since the evaluation circuit merely needs to consider an edge. In accordance with one approach, the locations at which the rectangle function (or another function) has an edge are referred to as a portion extending in conformity with a strictly monotonic function (that is, a strictly monotonically rising function or strictly monotonically falling function, depending on the direction of the edge, there being provided inbetween a portion that does not extend strictly monotonically but which is constant. It is sufficient, therefore, for the envelope to have only one portion in which a non-constant function defines the curve, that is, a strictly monotonic function, while other regions may by all means be provided as a not strictly monotonic function (for example a constant function), since the portion that includes the strictly monotonic function describes a feature for later detection. In accordance with a practical realization, the envelope may correspond to the sound signal obtained when an ultrasonic transducer is driven by a square-wave pulse, the impulse response of the transducer having a clear transient phase at the rising edge of the driving signal, during which the signal strength rises continuously, but not suddenly, with the steepness of the edge of the driving signal.

It is generally true to say that the regions of the received ultrasound pulse attributable to the transient phase of the transducer react less sensitively to differences in the properties of the transducers among themselves or to changes in the transducer properties, for example due to aging or fouling, than do subsequent regions. For this reason also, it is advantageous to make use of above all the transient phase of the received pulse both for determination of the coarse time difference and the fine time difference. In this case, the first inflection point of the envelope or the first maximum of the envelope may be used, the transient phase referring, for example, to the entire first rising edge of the envelope.

As already mentioned, the fine time difference is ambiguous since the phase of the carrier frequency is repeated periodically when the ultrasound propagation time varies by a range of more than one ultrasound period. The provision of the fine time difference therefore includes the detection of a phase difference between transmitted ultrasound pulse (or its transmission reference instant) and received ultrasound pulse. In this case, the instantaneous variation of the carrier signal is considered, that is, the instantaneous variation of the received ultrasound pulse and, where applicable, also of the transmitted pulse or its driving signal. In particular, it is possible to use features of the instantaneous variation for comparison, that is, for example, maximums, minimums or zero crossings and also inflection points of the carrier signal of the received ultrasound pulse. In particular, the ultrasound pulses (that is, those of the received ultrasound pulse) may each be modulated, mixed or multiplied with two periodic demodulation signals. In order to obtain the phase information, the demodulation signals are phase-shifted from each other, for example orthogonal square-wave signals or alternatively sine-wave or cosine-wave signals with a phase shift of 90°. The two results obtained for the relevant ultrasound pulse by modulation with different demodulation signals may be compared with each other, especially in averaged or integrated form, and set in relation to each other as a ratio in order to detect the phase. In accordance with another approach, the ultrasound pulses may be detected with the aid of a quadrature receiver in order to detect therefrom the phase shift between received and transmitted ultrasound pulse. In that case, the method provides for the two signals obtained by modulation, mixing or multiplication to be compared, especially to be compared for the received ultrasound pulse. That comparison between the signals obtained by modulation produces the phase information (for the transmitted ultrasound pulse as well as) for the received ultrasound pulse, since the difference between the two signals obtained by modulation is defined by the phase relative to the demodulation signals.

The phase of the received ultrasound pulse is determined especially by multiplying the pulse by the two demodulation signals, then low-pass-filtering (and/or decimating) and then finding from the resulting values the atan2 value based on the amplitude thereof or based on the power thereof. The phase formation may be integrated or summed over the entire ultrasound pulse, or preferably only for the region of the rising edge (for example up to the first maximum or inflection point) since that region is least affected by aging effects or differences between the transducers.

In accordance with a further embodiment, the coarse time difference is determined with high time resolution, but it is further processed with low time resolution (especially for the reason that the fine time difference already reflects the precise proportions). The envelope of the signal obtained by sensing the received ultrasound pulse and, where applicable, also the transmitted ultrasound pulse is described by a time-discrete signal having a low data rate and is used for further calculation. For example, the data rate used in comparing the envelope (of the received ultrasound pulse and, where applicable, also of the transmitted ultrasound pulse) is only a low multiple of the carrier frequency or also a non-integral multiple in that order of magnitude. The low sampling rate does not permit a particularly accurate detection of the time difference, but for the coarse time difference it is sufficient that the correct period to which the fine time difference applies is detected. The instantaneous variation may also be sampled with a sampling frequency that is not an integral multiple of the carrier frequency. The sampled signal may be decimated and/or may be limited in its maximum frequency or in its bandwidth by a low-pass filter or bandpass filter.

In addition, the signal used to detect the time differences may not be frequency-filtered or decimated relative to the received pulse (this applies to determination on the basis of the analog signal or the digital, sampled signal), or the sampled signal is filtered by a decimation filter. The decimation filter provides for simplification of a signal sampled at a higher sampling rate by combining a plurality of consecutive sampling points, for example by averaging within the sampled points so grouped, whereby a lower sampling rate is obtained and the individual values are based on an averaging of a signal sampled at a higher rate. The averaging blocks high frequency components, and therefore a decimation filter acts on the signal sampled at a higher rate in the sense of a low-pass filter. The averaging, in which individual consecutive values of the signal sampled at a higher rate are combined, may be regarded as a window integrator; the window integrator does not slide, however, but jumps from group to group in order to integrate (and, where applicable, also standardize) one group in each instance in order in that manner to form an average value.

The detection of the instantaneous amplitude variation may include one or more low-pass or bandpass filtering operations, and also a decimation which, where applicable, includes an interpolation.

The fine time difference is preferably provided as a proportion of the period length smaller than the period length of the carrier frequency. In particular, coarse time difference and fine time difference relate to a half-period length when the fine time difference does not contain sign information. It is preferred, however, that the fine time difference relates to the whole period length and thus offers period information in the range of 0 to 360° (for a period). In this case, the coarse time difference is provided, for example, as a rounded value, for example as an integral value corresponding to a multiple of a wavelength of the carrier frequency. The rounding reduces errors that arise in the detection of the coarse time difference, the information deleted in that manner being replaced by the fine time difference which provides a higher precision. The coarse time difference is preferably rounded to an integral multiple of an individual wavelength of the carrier frequency.

A further embodiment of the present invention provides that the fine time difference is provided for an instant that is at least a predefined minimum period of time after the beginning of the transmitted ultrasound pulse or the received ultrasound pulse. Accordingly, the point for which the fine time difference is detected does not lie at the edge of the envelope and, especially, does not lie at the beginning of the envelope. The minimum period of time is at least as long as the transient time of the ultrasonic transducer. The ultrasonic transducer is used for emitting, for receiving or for both. This avoids the fine time difference being provided for an instant at which the ultrasonic transducer is still in a transient state at the start of the ultrasound pulse with a correspondingly poor signal-to-noise ratio. This applies to the transient during transmitting, during receiving or preferably to both. The fine time difference is preferably provided or determined for an instant at which the variation of the ultrasound pulse has a particular feature. That feature may be provided by a relative maximum, a relative minimum, a zero crossing, an inflection point, a maximum gradient or the like. The detection of those features may be provided by derivation of the ultrasound pulse and by consideration of the time derivative, in which case, for example, the derivative is zero at a relative maximum or minimum and the time-derivative signal has a maximum (or minimum) at an inflection point. In that manner, a time reference is provided for the received pulse, with which the transmission time reference point may be compared in order to provide the fine time difference.

In accordance with a further embodiment, the fine time difference is provided by detecting a plurality of instantaneous phases existing during different instants within the same ultrasound pulse (that is, within the same envelope), provision being made by extrapolation of the instantaneous phases to an instant for which the fine time difference is to be provided. The instant may correspond, for example, to a zero crossing, a maximum, a minimum, an inflection point or an instant extrapolated from such features.

Furthermore, a shift between phase position and envelope that differs between two directions of measurement may be compensated for by updating. The expression “directions of measurement” refers to two different orientations relative to a flow that is to be measured, it being possible for the directions of measurement to differ, in particular, in magnitude relative to the flow, so that a first direction of measurement is inclined in a direction counter to the flow and a second direction of measurement is inclined in a direction with the flow or extends in the direction of flow. Such differences may result from different temperature or flow effects or alternatively from the broken symmetry caused by the flow, unlike a strictly reciprocal transmission system, the updating operation detecting the shift from past measurements and providing a compensation factor or a correction value for future shifts. The above-described reduction using a decimation filter (which combines a plurality of sampling points by averaging) may be provided by a Si² filter. The transfer function of the Si² filter is defined by (sin x/x)². In particular, decimation to one times or two times the signal frequency is advantageous since harmonics occurring in the demodulation are thereby suppressed. Signal frequency refers here to the carrier frequency. In particular, it is possible to use FIR filters to filter the received ultrasound pulse before it is utilized further. Such a deployment of FIR filters may be combined with the use of a decimation filter or may replace a decimation filter.

The method may include the determination of the phase and the amplitude, the phase information being used in the determination of the fine time difference, and the amplitude so obtained being used for the coarse time difference. The detection of the phase and the amplitude may be provided by a detector of the phase and the amplitude, it being possible in accordance with one embodiment for the received ultrasound pulse to have been filtered as described above (for example with a decimation filter or FIR filter) or not to have been filtered.

In accordance with a further embodiment, the propagation time measurement is carried out for a plurality of directions, the direction being based on the direction of flow within the spatial region being scanned.

In addition, in accordance with the present invention, the variation of the received ultrasound pulse may be used to calculate, on the basis of a tangent extrapolation, an intersection of the tangent to the point of the envelope of the ultrasound pulse having the maximum gradient with the time axis. That reference point may be used for detection of the coarse time difference by detecting the time offset at a corresponding instant of the transmitted ultrasound pulse, for example a rising edge of a driving signal of the transmitter.

The provision of the fine time difference may include the detection of a plurality of phase positions during the same pulse, the phase being extrapolated on the basis of those different phase points to an instant for which the coarse time difference is detected, i.e., for a reference point of the envelope.

The present invention further relates to a propagation time difference measuring device as defined in Claim 10. Further embodiments of that propagation time difference measuring device may include an FIR filter or a decimation filter as described above, which is connected between input of the received ultrasound pulse and coarse comparator or fine comparator. The propagation time difference measuring device may further include an extrapolation device which is connected to the fine comparator to extrapolate a plurality of results provided by the fine comparator and relating to the same ultrasound pulse to a desired instant. The desired instant may, for example, be provided by the coarse comparator, in which case the coarse comparator is connected to the extrapolator in order to input that extrapolation target instant. For phase detection, the propagation time difference measuring device may further include a quadrature circuit in order to compare the phase variations of the transmitted ultrasound pulse and the received ultrasound pulse. Preferred embodiments provide only a quadrature circuit for the received ultrasound pulse, the phase variation of the transmitted ultrasound pulse being provided by a signal generator of the propagation time difference measuring device or by a driver for a signal generator within the propagation time difference measuring device.

The propagation time difference measuring device may be provided by partly or completely programmable hardware such as a processor, where appropriate including hard-wired logic circuits, and by a memory which interacts with the processor and which stores program codes providing the functions described above. The propagation time difference measuring device may further include an input/output interface for delivering the respective data or signals to the processor from the outside or for passing the results produced by the processor to the outside, for example to a transducer or to an output device.

### BRIEF DESCRIPTION OF THE DRAWINGS

FIG. 1 shows an example of a received ultrasound pulse.

FIG. 2 shows the phase variation within the ultrasound pulse shown in FIG. 1.

FIG. 3 shows the variation of the value of the amplitude of the ultrasound pulse shown in FIG. 1.

FIG. 4 shows the signal variation of FIG. 3 after filtering with a decimation filter.

FIG. 5 shows a similar curve to that shown in FIG. 4, with a tangent construction.

FIG. 6 shows a block diagram of a propagation time difference measuring device according to the present invention.

### DETAILED DESCRIPTION OF THE INVENTION

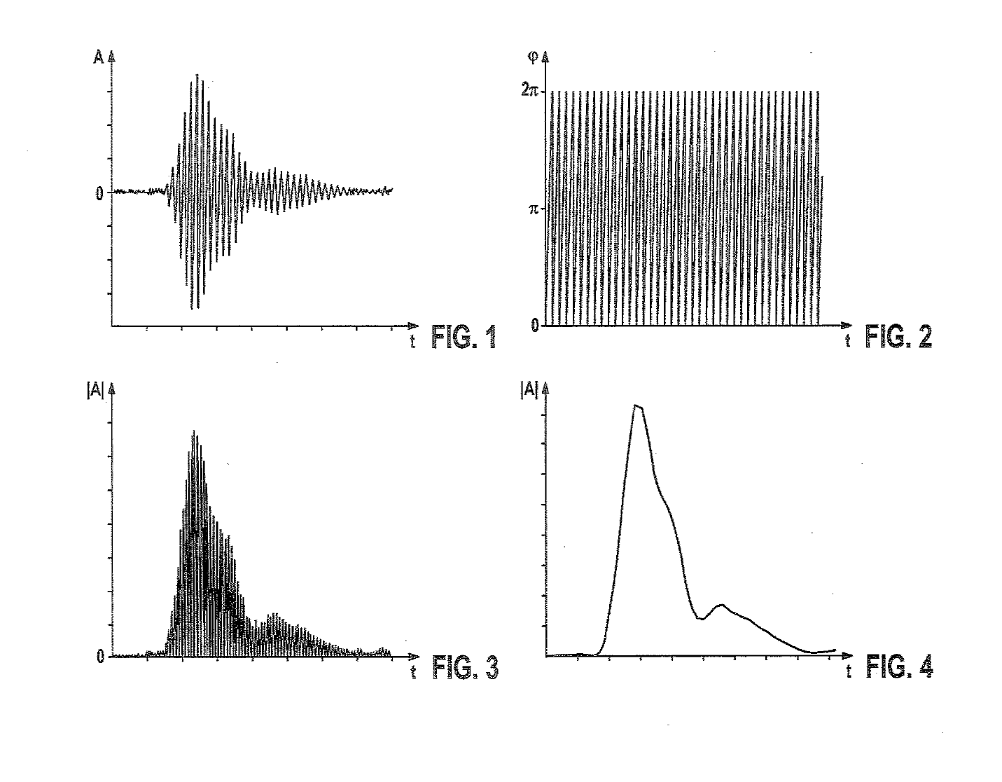

FIG. 1 shows an example of a received ultrasound pulse having an envelope that includes four portions with a strictly monotonic variation. After a quiescent time provided before those variations, a steeply rising portion begins, followed by a steeply falling portion. The steeply rising portion relates to the reaction of a real transducer, which is subject to inertia, to a rising square-wave edge of a driving signal. This is followed in turn by a gently rising portion which is followed by a gently falling portion until an amplitude of zero is reached again. The two outermost parts of the variation illustrated in FIG. 1 show the interfering effect of noise sources. The described rising and falling portions define the envelope in order to detect a coarse time difference by comparison with the transmitted ultrasound pulse. It will also be seen by reference to FIG. 1 that the carrier frequency is, at least to a rough approximation, constant with time.

FIG. 2 shows the phase variation of the received ultrasound pulse illustrated in FIG. 1 for a period of time during which the amplitude of the envelope is not zero. It will be seen from FIG. 2 that the amplitude varies sinusoidally between 0 and 2π, the variation being performed at a frequency corresponding to the carrier frequency of the transmitted ultrasound pulse (and thus also of the received ultrasound pulse). On consideration of FIGS. 1 and 2 it will be apparent that, without precise resolution, it is not possible to determine from FIG. 1 a particularly exact coarse time difference and that it is not possible to determine from FIG. 2 a time difference that would be unambiguous for the instant within the envelope.

FIG. 3 shows the received ultrasound pulse illustrated in FIG. 1, with reference to the value of the amplitude. That amplitude value may also be regarded as the signal strength, the individual regions of the signal illustrated in FIG. 1 being reflected in FIG. 3. At the two ends of the illustrated function, regions will be seen in which the envelope or the signal strength is 0 and therefore only a noise signal is shown. Between those regions, there are four regions, first a steeply rising region, followed by a steeply falling region, followed by a gently rising region, followed by a gently falling region until the amplitude range of substantially 0 is reached again. In accordance with a preferred embodiment, the signal shape shown in FIG. 3 corresponds to the signal shape used to provide the coarse time difference. For example, the first, steeply rising edge may be used to serve as a feature that is present both in the transmitted ultrasound pulse and in the received ultrasound pulse, so that the two ultrasound pulses may be compared with each other according to that feature in order to determine the coarse time difference.

In an especially preferred embodiment, it is not the instantaneous amplitude shown in FIG. 3 that is used as the starting point for the envelope for calculation of the coarse time difference, but a simplified signal shape as may be seen in FIG. 4. FIG. 4 shows a variation of an amplitude value substantially corresponding to the envelope, with the variation according to carrier frequency no longer being seen. A variation as shown in FIG. 4 is obtained from FIG. 3 by time averaging, especially by filtering with a decimation filter. A similar variation would also be obtained by filtering with a low-pass filter that suppresses the carrier frequency. In particular, the variation shown in FIG. 4 is obtained by filtering with a decimation filter when the decimation filter takes only the maximum value of a group of sampling points, and the sampling points to be combined in that manner substantially encompass in terms of time a half-period (or a whole period) or a multiple thereof.

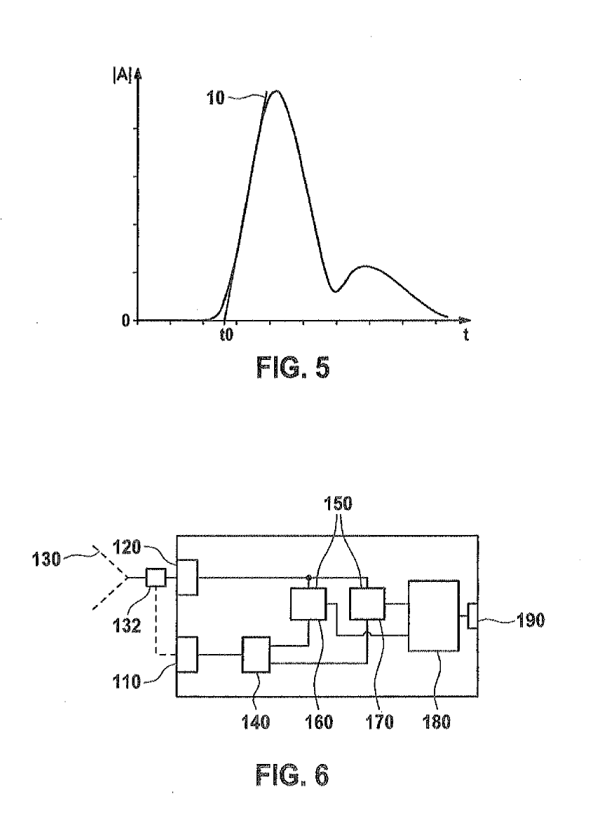

In FIG. 5, a further example of a curve of an envelope is shown, as may be used in the present invention. FIG. 5 serves to illustrate a method step with which it is possible to determine an instant t0 for which, in accordance with a preferred embodiment, the coarse time difference, the fine time difference or both may be detected. In accordance with this embodiment, the gradient of the envelope is detected, and from the gradient the maximum gradient is determined. In particular, there is determined from the detected gradient the instant at which the maximum gradient occurs. The curve shown in FIG. 5 has a gradient that decreases again until a first peak is reached. The point of the maximum of that gradient gives an instant at which the gradient of the envelope is at a maximum. A tangent 10 intersecting the t-axis is drawn to that point of the envelope. Tangent 10 is provided by the instant at which the detected gradient of the envelope attains a maximum, there being used in addition to the instant of the maximum gradient also the value of the maximum gradient itself as a tangent gradient. Extrapolation using the resulting equation of the tangent line gives an instant t0 for which the coarse time difference and, especially, the fine time difference is determined and which provides in the calculation of the coarse time difference a reference point for the envelope of the received ultrasound signal. When used to provide the coarse time difference, tangent 10 may be used to compare transmitted and received ultrasound pulses with each other in order to determine the coarse time difference. Since t0 substantially represents the beginning of the envelope (that is, of the envelope with an amplitude greater than zero), that instant t0 may also be used to determine the coarse time difference on the basis of a trigger signal which marks the beginning of the transmitted ultrasound pulse. Owing to the known excitation time of the transducer or predefined delays between start of driving and emission of the signal by the transducer, it is possible for such delays to be taken into account, so that the coarse time difference is found as the difference between instant of triggering and t0, with the delay known from the system being added to (or subtracted from) that term. Thus, if the start of the driving of the ultrasonic transducer by the transmitted ultrasound pulse is known, for example with the aid of a trigger signal, then it is merely necessary to detect point t0 on the basis of the maximum gradient of the first rising edge of the envelope in order to calculate the coarse time difference as the difference between t0 and the instant of triggering, with a predetermined delay that reflects the system being taken into account in order for delays inherent in the system to be taken into account in the interpolation of t0. Tangent 10 has the maximum gradient of the first rising edge of the envelope and intersects the envelope at the point where the gradient of the first rising edge is at a maximum, since, as already described, both gradient and a point of the tangent are known.

FIG. 6 shows a block diagram of an embodiment of the propagation time difference measuring device according to the present invention, having an output 110 for outputting a signal describing the transmitted ultrasound pulse, and an input for receiving a received ultrasound pulse. For that purpose, output 110 and input 120 may be connected to an ultrasonic transducer 130, shown by dashed lines, preferably via a changeover switch 132 which switches between transmit and receive mode so that the same transducer 130 may be used both as receiver and as transmitter. It is also possible for a second changeover switch (not shown in FIG. 6) and a second ultrasonic transducer to be used so that either the first ultrasonic transducer is used as transmitter and the second as receiver or vice versa, the corresponding transmit-receive direction being reversible. As already described, both changeover switch 132 and ultrasonic transducer 130 are not necessarily part of the propagation time difference measuring device according to the present invention. Rather, output and input are preferably configured to be connected to ultrasonic transducer 130 via changeover switch 132.

The propagation time difference measuring device further includes a signal source 140 for generating a signal which may be output via output 110 to an ultrasonic transducer 130 connectable thereto.

The propagation time difference measuring device further includes a time-detection device 150 which, in the embodiment illustrated in FIG. 6, is connected to signal generator 140 in order to obtain therefrom at least a trigger signal or another item of time information that indicates the beginning of the transmitted ultrasound pulse or transmission reference instant. Input 120 is also connected to time-detection device 150 so that a time difference between received ultrasound pulse and transmitted ultrasound pulse may be detected. For that purpose, time-detection device 150 includes a coarse comparator 160 which detects a coarse time difference on the basis of the envelope, as described above. In order, for example, to be able to carry out the steps described with reference to FIG. 5, coarse comparator 160 includes a differentiator, a device for detecting the maximum gradient, and an extrapolating device with which the instant t0 for the received ultrasound pulse may be provided as described above. That instant t0 may then be compared with the time information supplied by signal generator 140, with coarse comparator 160 further including, for example, a memory or another device (not shown) that provides a delay inherent in the system, which may be taken into account in the determination of the coarse time difference.

Time-detection device 150 further includes a fine comparator 170 which examines the phase variation of the transmitted or switching pulse and compares them with each other. For that purpose, the fine comparator receives from signal generator 140 a signal describing the transmitted ultrasound pulse and its instantaneous amplitude variation.

Both fine comparator 170 and coarse comparator 160 are connected to a combination device 180 of the propagation time difference measuring device according to the present invention in order to transmit thereto both the coarse time difference and the fine time difference. Combination device 180 is configured to combine the coarse and fine differences, especially at least two coarse and fine time differences of consecutive detection steps or time differences of opposite directions of transmission. Combination device 180 includes an individual-combination device (not shown) and is further connected to a result output 190 of the propagation time difference measuring device of FIG. 6 in order to provide at that result output a signal representing the combined coarse and fine differences as the propagation time difference. Combination device 180, together with the individual-combination device, is configured to combine first the coarse time differences of opposite directions of transmission to form an individual combination and to combine the fine time differences of opposite directions of transmission to form an individual combination. Those individual combinations are again combined by the individual-combination device to provide the fine time differences in accordance with the coarse time differences for a broad propagation time detection range or to give a higher accuracy to the coarse time differences in accordance with the fine time differences.

The result output 190 is configured to be connected to a further evaluation device which, on the basis of the detected propagation time difference determined by the propagation time difference measuring device of FIG. 6, infers the flow speed within the space through which the ultrasound pulses propagate. If a plurality of propagation time difference measuring devices are used or if a plurality of time differences are used, they preferably relate to the same space into which ultrasound pulses are emitted.

In order to transmit the ultrasound signals alternately (or switchably) in opposite directions, the propagation time difference measuring device preferably further includes a changeover switch which is connected to the output and the input in order for the transducers connectable thereto to be operated in a switchable manner as transmitter and receiver alternately.

1-10. (canceled)

11. A method for measuring a propagation time difference, comprising:
transmitting an ultrasound pulse at a transmission reference instant into a spatial region;
receiving an ultrasound pulse corresponding to the transmitted ultrasound pulse from the spatial region; and
determining a propagation time difference by:
providing a coarse time difference by comparing the transmission reference instant with an envelope of the received ultrasound pulse, for at least two cycles of sending and receiving which are carried out with mutually opposite directions of transmission;
providing a fine time difference by comparing the transmission reference instant with an instantaneous variation of the received ultrasound pulse, for the at least two cycles of sending and receiving which are carried out with mutually opposite directions of transmission;
providing (i) a combination of the fine time differences for the opposite directions of transmission as a first individual combination, and (ii) a combination of the coarse time differences for the opposite directions of transmission as a second individual combination; and
providing the propagation time difference as a combination of the first and second individual combinations.

12. The method as recited in claim 11, wherein:
the provision of a combination of the coarse time differences includes providing a term which combines the coarse time differences in the form of a difference; and
the provision of a combination of the fine time differences includes providing a term which combines the fine time differences in the form of a difference.

13. The method as recited in claim 12, wherein the provision of the propagation time difference includes:
providing a first term as the first individual combination of the fine time difference, the first term describing the difference between the fine time differences; and
providing a second term as the second individual combination of the coarse time difference, the second term being provided with an argument which includes the coarse time differences in the form of a difference, the argument of the second term including a correction summand which includes the difference between the fine time differences, and a rounding correction constant updated in accordance with past rounding processes, wherein the provision of the second term includes (i) combining the first term and the argument, and (ii) rounding the combination resulting from the first term and the argument.

14. The method as recited in claim 11, wherein:
the fine time difference depends on an ambiguous phase difference; and
the provision of the fine time difference includes: detecting an instantaneous amplitude variation of the received ultrasound pulse;
comparing the instantaneous variation of the received ultrasound pulse with a transmission reference instant of the transmitted ultrasound pulse in order to provide the fine time difference as the result of the variation, the comparison including: one of (i) detecting a feature of the instantaneous amplitude variation of the received ultrasound pulse, said feature being linked to the transmission reference instant, or (ii) modulating the received ultrasound pulse with two periodic demodulation signals which are shifted from each other by a magnitude of substantially 90°, and wherein the provision of the fine time difference includes comparing a first phase value obtained from a comparison of the modulated signals with a second phase value which describes the transmission reference instant.

15. The method as recited in claim 11, wherein the provision of the individual combination of the coarse time differences includes: providing the difference of the coarse time difference minus the individual combination of the fine time differences, as an integral multiple of a period length of the carrier frequency; wherein the method further includes: providing the individual combination of the fine time differences as a proportion of the period length less than the period length; and combining the individual combination of the coarse time differences of opposite directions of transmission with the individual combination of the fine time differences of opposite directions of transmission, the resulting sum corresponding to the propagation time difference.

16. The method as recited in claim 11, wherein the fine time differences and the coarse time differences are determined for instants of the received ultrasound pulse which lie a predefined minimum time period after the beginning of one of (i) transmission of the transmitted ultrasound pulse or (ii) excitation of the transducer to generate the transmitted ultrasound pulse, the predefined minimum time period being at least as long as the sum of a minimum transmission time period defined by the sound propagation path of the transmission and at least one of a transient time and a response time of an ultrasonic transducer used for transmitting.

17. The method as recited in claim 11, wherein a reception reference instant is provided for the received ultrasound pulse, the coarse time difference being determined on the basis of the reception reference instant, the reception reference instant corresponding to an instant at which the magnitude of one of (i) the envelope or (ii) the gradient of the envelope has a one of the first relative maximum of the envelope or the first zero crossing of the envelope.

18. The method as recited in claim 11, wherein the provision of the fine time difference includes:
detecting a plurality of phase values applying to different times within the same ultrasound pulse; and
extrapolating the phase values to a value which corresponds to the fine time difference.

19. A propagation time difference measuring device, comprising:
a transmitter configured to transmit ultrasound pulses in two mutually opposite directions of transmission;
an output for emitting, for each transmitted ultrasonic pulse, a signal describing the transmitted ultrasound pulse including an envelope and a carrier frequency;
an input for receiving ultrasound pulses corresponding to the transmitted ultrasound pulses;
a time-detection device configured to detect a propagation time difference using the received ultrasound pulse and a transmission time reference of the transmitted ultrasound pulse, wherein the time-detection device includes:
a coarse comparator configured to compare the transmission time reference with an envelope of the received ultrasound pulse, the coarse comparator providing a coarse time difference between the transmitted ultrasound pulse and the received ultrasound pulse as the result;
a fine comparator configured to compare the transmission time reference with the instantaneous amplitude of the received ultrasound pulse, the fine comparator providing a fine time difference between the transmitted ultrasound pulse and the received ultrasound pulse as the result;
an individual-combination device connected to the coarse comparator and the fine comparator to receive and combine the coarse and fine time differences provided by the coarse comparator and the fine comparator, wherein the individual-combination device is configured to combine the coarse time differences of opposite directions of transmission to form a first individual combination and to combine the fine time differences of opposite directions of transmission to form a second individual combination; and
a second combination device connected to the individual-combination device to receive and combine the first and second individual combinations of the coarse and fine time differences, wherein the second combination device is further connected to a result output which outputs a signal describing the combined first and second individual combinations as a propagation time difference.

20. The propagation time difference measuring device as recited in claim 19, wherein:
the individual-combination device is configured to provide the difference between the coarse and the fine time differences of ultrasound pulses of opposite directions of transmission;
the second combination device is configured to add the second individual combination of the fine time differences to the result of a rounding device of the combination device; and
the rounding device is connected to the individual-combination device and is configured to round a term which includes the first and second individual combinations of the coarse time differences and the fine time differences as one of (i) a difference between or (ii) a sum of the individual combinations.
